(19) United States
(12) Patent Application Publication
(10) Pub. No.: US 2010/0315429 A1
(43) Pub. Date: Dec. 16, 2010

(54) VISUAL DISPLAY MEASUREMENT AND CALIBRATION SYSTEMS AND ASSOCIATED METHODS

(76) Inventor: Ronald F. Rykowski, Bellevue, WA (US)

Correspondence Address: PERKINS COIE LLP;PATENT-SEA, P.O. BOX 1247, SEATTLE, WA, 98111-1247, US

(21) Appl. No.: 12/715,307

(22) Filed: Mar. 1, 2010

Related U.S. Application Data
(60) Provisional application No. 61/186,316, filed on Jun. 11, 2009.

(51) Int. Cl. G09G 5/02

(52) U.S. Cl. 345/589

(57) ABSTRACT

The present disclosure is directed to visual display measurement and calibration systems and associated methods. A system in accordance with one embodiment includes, for example, a visual display measurement device configured to contact one or more selected regions of a visual display sign. The visual display measurement device includes a light integrating and collection portion and a color measurement device configured to receive light from the visual display sign under test after the light passes through the light integrating and collecting portion. The system can also include a computer having a processor and memory operably coupled to the color measurement device. The computer is configured to calculate correction factors for color and brightness data from the color measurement device.

### CROSS-REFERENCE TO RELATED APPLICATION

The present application claims priority to pending U.S. Provisional Patent Application No. 61/186,316, filed Jun. 11, 2009, and incorporated herein by reference in its entirety.

### TECHNICAL FIELD

The present disclosure relates generally to visual display measurement and calibration systems and associated methods.

### BACKGROUND

Visual display signs have become commonplace in sports stadiums, arenas, and public forums throughout the world. The signs are typically very large, often measuring several hundred feet in size. Because of their immense size, the signs must be assembled and installed on-site using a series of smaller panels, which are themselves further comprised of a series of modules or blocks. Each module or block is made up of hundreds of individual light-emitting elements or “pixels” arranged in a desired pattern (e.g., a series of rows and columns). In turn, each pixel is made up of a plurality of light-emitting points, e.g., one red, one green, and one blue. The light-emitting points are termed “subpixels.” The subpixels can be controlled independently to produce a multitude of different colors. The modules or blocks of the display are internally connected to each other by way of a bus system. A computer or central control unit sends graphic information to the different modules, which then display the graphic information as images and text on the sign.

Although each module can be calibrated during production, the individual modules often do not match each other in terms of color and/or brightness for a variety of different reasons. For example, the individual modules may not match because of manufacturing tolerances or variances in the calibration process used for the individual modules. In addition, the electronics powering the various modules after installation have tolerances that affect the power and temperature of the subpixels, which can in turn affect the color and brightness of the individual pixels of a given module. Furthermore, as the sign ages, the light output of each subpixel may degrade. Because the degradation is not uniform for each color of subpixel, or even for each subpixel of the same color, the uniformity and color point of the sign will degrade over time. If a new module is used to replace a defective module for a screen, the new module can be different in brightness and color from surrounding modules which have aged in the field for some time. This can cause color shifts, visible edges around individual screen modules, and pixel-to-pixel non-uniformity. Accordingly, when defective modules need to be replaced, new modules may need to be calibrated to match the other modules of the visual display to display colors clearly, uniformly, and accurately. The immense size of most visual display signs, however, makes recalibration of the full display in a testing center impracticable. Likewise, it is not practical or cost-effective to completely disassemble the visual display and bring in the individual modules to a testing center for recalibration.

### BRIEF DESCRIPTION OF THE DRAWINGS

FIG. 1 is a partially schematic, isometric illustration of a visual display measurement and calibration system configured in accordance with an embodiment of the disclosure.

FIG. 2 is an isometric view of the visual display measurement device of FIG. 1.

FIG. 3 is a side view of the visual display measurement device of FIG. 1.

FIG. 4 is a schematic, side cross-sectional view of the visual display measurement and calibration system of FIG. 1.

FIG. 5 is a partially schematic, side view a visual display measurement device configured in accordance with another embodiment of the disclosure.

FIG. 6 is a partially schematic, side view a visual display measurement device configured in accordance with still another embodiment of the disclosure.

### DETAILED DESCRIPTION

### A. Overview

The following disclosure describes visual display measurement and calibration systems and associated methods. As described in greater detail below, for example, a visual display measurement and calibration system configured in accordance with one embodiment of the disclosure comprises a visual display measurement device configured to contact one or more selected regions of a visual display sign. The visual display measurement device includes a light integrating and collection portion and a color measurement device configured to receive light from the visual display sign under test after the light passes through the light integrating and collecting portion. The system can also include a computer having a processor and memory operably coupled to the color measurement device. The computer is configured to calculate correction factors for color and brightness data from the color measurement device.

Another embodiment of the disclosure is directed to a system comprising a light collection cone configured to contact one or more selected portion of a visual display sign under test. The light collection cone comprises a first end configured to contact the visual display sign, a second end spaced apart from the first end, and an optical axis extending between the first end and the second end. The system can also include a color measurement device carried by the light collection cone and adjacent to the second end of the light collection cone. The color measurement device is configured to receive light from the visual display sign under test after the light passes along the optical axis from the first end to the second end. The system can further include a test interface operably coupled to the color measurement device. The test interface, which comprises a processor and memory, is configured to (a) compile and manage color and brightness data from the color measurement device, (b) calculate correction factors for the color and brightness data based on reference color and brightness data, and (c) upload the processed correction data to firmware and/or software controlling the visual display sign under test.

Still another embodiment of the disclosure is directed to a method for measuring and calibrating a visual display. The method comprises, for example, receiving color and brightness data from one or more selected portions of a visual display sign using a handheld visual display measurement device. The visual display measurement device includes (a) a light collection cone configured to directly contact the one or more selected portions of the visual display sign under test, and (b) a color measurement device carried by the light collection cone and configured to receive light from the visual display sign after the light passes through the light collection cone. The method further includes calculating correction factors for color and brightness data from the color measurement device. The correction factors are calculated, for example, using a computing device operably coupled to the color measurement device. In several embodiments, the method can also include sending the correction factors to firmware and/or software controlling the visual display sign

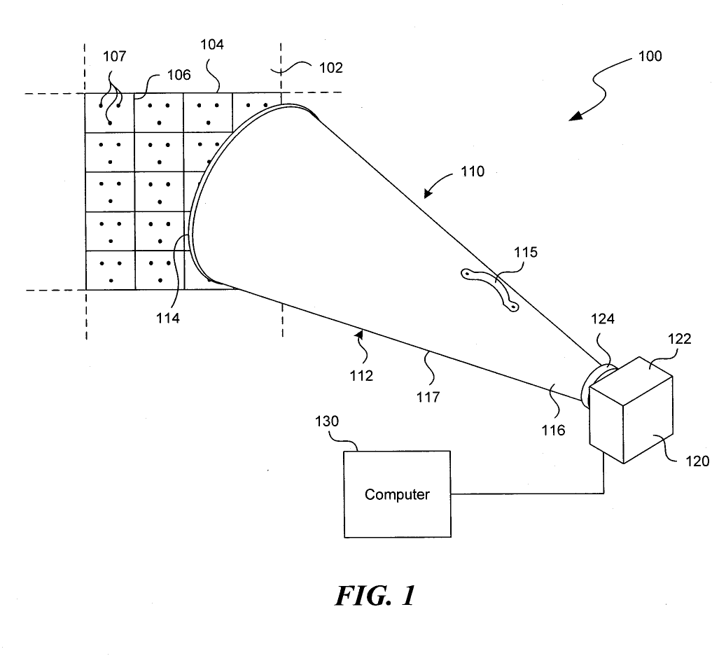

Many specific details of certain embodiments of the disclosure are set forth in the following description and in FIGS. 1-6 to provide a thorough understanding of these embodiments. Well-known structures, systems, and methods often associated with such systems have not been shown or described in detail to avoid unnecessarily obscuring the description of the various embodiments of the disclosure. In addition, those of ordinary skill in the relevant art will understand that additional embodiments may be practiced without several of the details described below.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number, respectively. Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Additionally, the words “herein,” “above,” and “below” and words of similar import, when used in this application, shall refer to this application as a whole and not to any particular portions of this application.

### B. Embodiments of Visual Display Measurement and Calibration Systems and Associated Methods

FIG. 1 is a partially schematic, isometric illustration of a visual display measurement and calibration system 100 configured in accordance with an embodiment of the disclosure. As described in greater detail below, the system 100 is configured to perform correction of color and/or brightness of modules used in visual display signs. The system 100 includes a visual display measurement device 110 positioned to contact one or more selected regions of a visual display sign 102. For purposes of illustration, only a portion of the visual display sign 102 is shown and the device 110 is shown at an initial position spaced apart from the sign 102 before the device 110 is brought into contact with the selected region of the sign 102.

The sign 102 is assembled using a series of modules or blocks or panels 104. Each module 104 is made up of a plurality of light-emitting elements or pixels 106. In turn, each pixel 106 is composed of individual light emitting points or subpixels 107 (e.g., light emitting diodes (LEDs)). In the illustrated embodiment, for example, each pixel 106 is composed of three subpixels 107 (e.g., one red, one green, one blue). The brightness level of each subpixel 107 can be varied. For example, the additive primary colors represented by the red subpixel, the green subpixel, and the blue subpixel can be selectively combined to produce a wide range of different colors on the sign 102. In other embodiments, however, the pixels 106 may have a different number of subpixels 107. In addition, a different color space (e.g., cyan, magenta, and yellow) may be used in lieu of the red, green, and blue (RGB) color space as a basis for processing and display of color images on the sign 102.

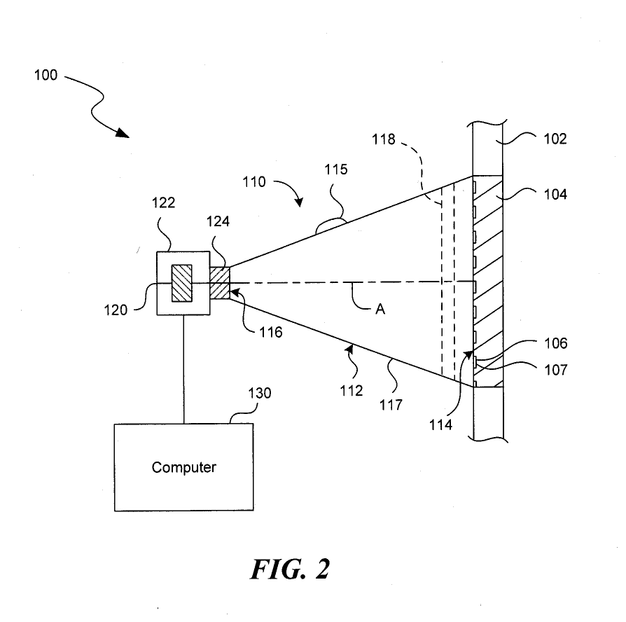

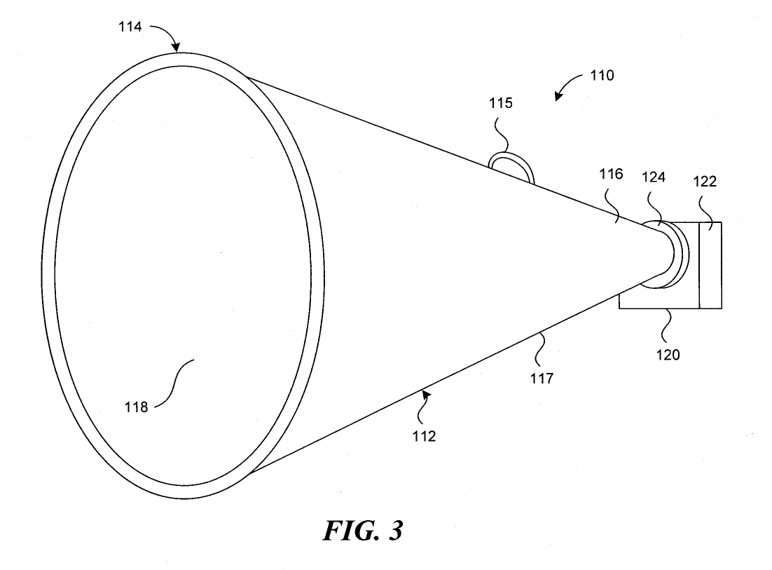

FIG. 2 is an isometric view of the visual display measurement device 110, and FIG. 3 is a side view of the device 110. Referring to FIGS. 1-3 together, the visual display measurement device 110 includes a light integrating and collecting portion 112 (e.g., a cone) operably coupled to a color measurement device 120 (e.g., a spectrometer or colorimeter). The light integrating and collecting portion 112 has a first or front portion 114 configured to be placed in contact with the module 104 and a second or rear portion 116 spaced apart from the first portion 114. An optical axis A extends through the light integrating and collection portion 112 between the first portion 114 and the second portion 116. The front portion 114 can have a variety of different sizes based, at least in part, on the size of the selected region(s) of the sign 102 to be tested. The light integrating and collecting portion 112 can also include one or more handles 115 positioned to allow an operator (not shown) to easily move the device 110 into the desired position during operation.

The wall(s) 117 of the light integrating and collecting portion 112 are composed of a material that is opaque to ambient light so that the device 110 can be used in typical ambient light conditions. The device 110 can also include light collection optics 118 (shown schematically in FIG. 1B) within the light integrating and collecting portion 112 between the front and rear portions 114 and 116. In the illustrated embodiment, the light collection optics 118 include one or more light diffusers. In other embodiments, however, the light collection optics 118 can include a variety of different optical elements. In still other embodiments, the device 110 may not include light collection optics 118.

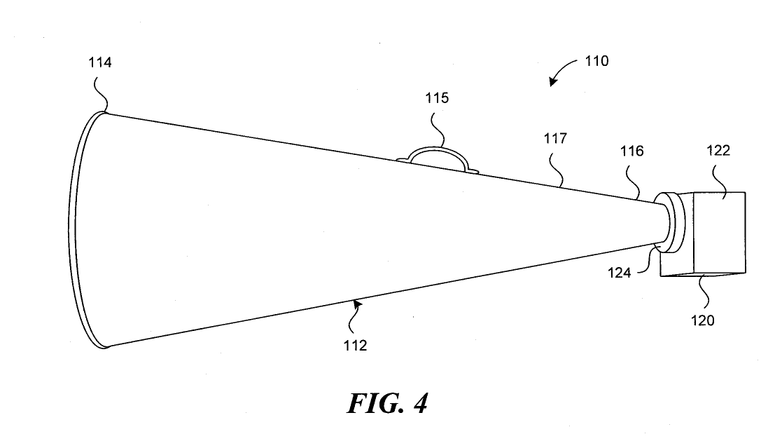

FIG. 4 is a schematic, side cross-sectional view of the system 100 of FIG. 1. In the arrangement shown in FIG. 4 together, the device 110 is shown in contact with the module 104 to be tested. Referring to FIGS. 1-4 together, the color measurement device 120 (e.g., a charge-coupled device (CCD) spectrometer) is carried within a housing 122 and positioned to receive light from the module 104 under test. As is known to those of skill in the art, CCD spectrometers are instruments used to measure properties of light (e.g., wavelength, energy, intensity) over a specific portion of the electromagnetic spectrum (e.g., infrared, visible, ultraviolet, X-rays, etc.). In the illustrated embodiment, the housing 122 is operably coupled to the light integrating and collecting portion 112 via a connector 124. The connector 124 is an optional component, however, and may not be included in some embodiments.

The device 110 is configured to capture color and brightness data from the selected module 104 and transfer the captured data to a computer or interface 130 operably coupled to the color measurement device 120. The computer 130 is configured to compile and manage color and brightness data from the device 110 and perform a series of calculations to determine the appropriate correction factors that should be made to the data. In one embodiment, for example, the color and brightness data from the module 104 can be compared against a specific reference color and brightness target and appropriate correction factors can be calculated based on the comparison. In another embodiment, however, the color and brightness data from the module 104 can be compared against color and brightness data from one or more reference modules and correction factors can be calculated to cause the subject module to match the reference module(s). One suitable method for performing such calculations is described in U.S. patent application Ser. No. 10/455,146, filed Jun. 4, 2003, and incorporated herein by reference in its entirety. After collecting the desired data, the processed correction data can be uploaded from the computer 130 to the firmware and/or software controlling the sign 102 and used to recalibrate the individual color and/or brightness of the light-emitting elements of the module 104.

The computer 130 can be a personal/laptop computer having a processor and memory with software for data acquisition and analysis. In the illustrated embodiment, the computer 130 is a separate component coupled to the color measurement device 120 via a link (e.g., a USB cable). In other embodiments, however, the computer 130 may be integral with the color measurement device 120 and carried within the housing 122. In still other embodiments, the computer 130 may have a different configuration and/or arrangement relative to the color measurement device 120. For example, those skilled in the relevant art will appreciate that aspects of the disclosure can be practiced with other communications, data processing, or computer system configurations. Further details regarding suitable computing environments are discussed below in Section C.

In operation, an operator (not shown) moves the light integrating and collecting portion 112 into contact with the selected module 104 (e.g., a defective or newly installed module) and begins capturing color and brightness data from the module 104. In some embodiments, the device 110 can be held stationary against the module 104 during testing. In other embodiments, however, the device 110 may be moved around the module 104 or other selected portions of the sign 102 during testing. Because the device 110 can be held in place against the module 104 and does not require long working distances, the device 110 can be easily manipulated by a single person and does not require any special setup or precise alignment for testing. Moreover, because the device 110 is lightweight and designed for use in the field, the module 104 does not need to be removed from the sign 102 for testing. Rather, the module 104 can be tested in place and recalibrated onsite.

As mentioned previously, in at least some embodiments the software on the computer 130 can include the ability to measure one or more additional modules (e.g., neighboring known good modules) as a reference and then correct the module under test to match the reference module(s). One advantage of this feature is that it is expected to inhibit and/or prevent problems associated with calibration uncertainty and envioronmentally-caused differences between the reference module(s) and the module under test because the modules are measured and calibrated using the same device (e.g., the device 110) and in the same environmental conditions.

Another feature of the device 110 is that the device only includes a color measurement device and does not require a digital camera or other complex optical elements or features for operation. One advantage of this feature is that it is expected to significantly reduce the complexity and costs associated with manufacturing and operating the device 110 as compared with conventional devices, such as expensive spot spectroradiometers and imaging colorimeters. Another advantage of this feature is that the device 110 can be used in normal ambient lighting conditions, while a spot spectroradiometer or imaging colorimeter typically require an environment in which all ambient lighting is off.

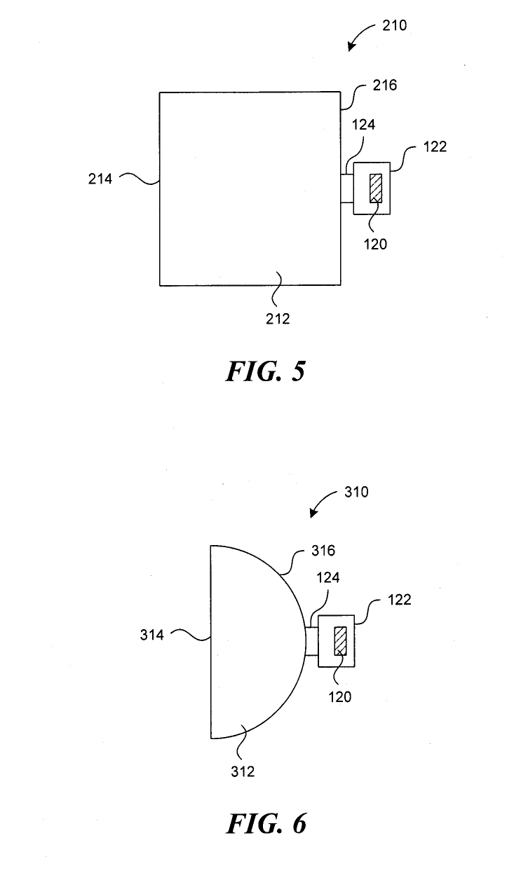

FIG. 5 is a partially schematic, side view of a visual display measurement device 210 configured in accordance with another embodiment of the disclosure. The device 210 can include many of the same features and advantages as the device 110 described above with reference to FIGS. 1-4, and can be used with the visual display measurement and calibration system 100 or other suitable systems. The device 210 differs from the device 110 described above with reference to FIGS. 1-4 in that the device 210 includes a light integrating and collecting portion 212 having a different configuration. In particular, the light integrating and collecting portion 212 of the device 210 is rectilinear rather than conical. The light integrating and collecting portion 212 has a front portion 214 sized and configured to be placed in contact with a selected portion of a visual display sign, and a rear portion 216 spaced apart from the first portion. As with the device 110 described above, the front portion 214 can have a variety of different sizes based, at least in part, on the size of the selected region(s) of the sign to be tested.

FIG. 6 is a partially schematic, side view of a visual display measurement device 310 configured in accordance with still another embodiment of the disclosure. The device 310 can include many of the same features and advantages as the devices 110 and 210 described above, and can be used with the visual display measurement and calibration system 100 or other suitable systems. The device 310 differs from the devices 110 and 210 in that the device 310 includes a light integrating and collecting portion 312 having yet another different configuration. In this embodiment, the light integrating and collecting portion 312 of the device 310 is a hemisphere having a front portion 314 sized and configured to be placed in contact with a selected portion of a visual display sign, and a rear portion 316 spaced apart from the first portion. As with the devices 110 and 210 described above, the front portion 314 can have a variety of different sizes based, at least in part, on the size of the selected region(s) of the sign to be tested. In still other embodiments, the light integrating and collecting portion can have a variety of other shapes and/or configurations.

### C. Suitable Computing Environments

Various aspects of the technology described herein can be implemented in suitable computing environments. Although not required, aspects and embodiments of the technology will be described in the general context of computer-executable instructions, such as routines executed by a general-purpose computer, e.g., a server or personal computer. Those skilled in the relevant art will appreciate that the described technology can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers, and the like. The described technology can be embodied in a special purpose computer or data processor that is specifically programmed, configured, or constructed to perform one or more of the computer-executable instructions explained herein. Indeed, the term “computer,” as used generally herein, refers to any of the above devices, as well as any data processor or any device capable of communicating with a network, including consumer electronic goods such as handheld devices or other electronic devices having a processor and other components, e.g., network communication circuitry.

The described technology can also be practiced in distributed computing environments, where tasks or modules are performed by remote processing devices, which are linked through a communications network, such as a Local Area Network (“LAN”), Wide Area Network (“WAN”), or the Internet. In a distributed computing environment, program modules or sub-routines may be located in both local and remote memory storage devices. Aspects of the technology described herein may be stored or distributed on computer-readable media, including magnetic and optically readable and removable computer discs, magnetic cassettes, tape drives, flash memory cards, digital video disks (DVDs), Bernoulli cartridges, RAMs, ROMs, smart cards, stored as firmware in chips (e.g., EEPROM chips), etc. Indeed, any medium for storing or transmitting computer-readable instructions and data may be employed, including a connection port to or node on a network such as a local area network (LAN), wide area network (WAN), or the Internet. Alternatively, aspects of the disclosure may be distributed electronically over the Internet or over other networks (including wireless networks). Those skilled in the relevant art will recognize that portions of the described technology may reside on a server computer, while corresponding portions reside on a client computer. Data structures and transmission of data particular to aspects of the described technology are also encompassed within the scope of the described technology.

From the foregoing, it will be appreciated that specific embodiments of the disclosure have been described herein for purposes of illustration, but that various modifications may be made without deviating from the spirit and scope of the technology. For example, the devices described above may include a colorimeter rather than a spectrometer. Moreover, different type of spectrometers could be used in lieu of a CCD spectrometer. Additionally, structures and/or processes described in the context of particular embodiments may be combined or eliminated in other embodiments. Furthermore, while various advantages associated with certain embodiments of the disclosure have been described above in the context of those embodiments, other embodiments may also exhibit such advantages, and not all embodiments need necessarily exhibit such advantages to fall within the scope of the disclosure. Accordingly, the disclosure is not limited except as by the appended claims.

I/We claim:

1. A visual display measurement and calibration system, comprising:
a visual display measurement device configured to contact one or more selected regions of a visual display sign, wherein the visual display measurement device includes—
a light integrating and collection portion; and
a color measurement device configured to receive light from the visual display sign under test after the light passes through the light integrating and collecting portion; and
a computer having a processor and memory operably coupled to the color measurement device and configured to calculate correction factors for color and brightness data from the color measurement device.

2. The system of claim 1 wherein the light integrating and collection portion has a generally conical shape with a first end configured to contact the one or more selected regions of the visual display sign and a second end spaced apart from the first portion and adjacent to the color measurement device.

3. The system of claim 2 wherein the light integrating and collection portion further comprises one or more optical elements positioned between the first and second ends.

4. The system of claim 3 wherein the individual optical elements comprise light diffusers.

5. The system of claim 2, further comprising a housing adjacent to and operably coupled to the second end of the light integrating and collection portion, and wherein the color measurement device is carried within the housing.

6. The system of claim 1 wherein the color measurement device comprises a CCD spectrometer.

7. The system of claim 1 wherein the color measurement device comprises a colorimeter.

8. The system of claim 1 wherein the computer is further configured to upload the correction factors to firmware and/or software controlling the visual display sign.

9. The system of claim 1 wherein the light integrating and collection portion has a rectilinear configuration.

10. The system of claim 1 wherein the light integrating and collection portion comprises a hemisphere.

11. The system of claim 1 wherein the light integrating and collection comprises an external wall composed of a material that is opaque to ambient light.

12. The system of claim 1 wherein the computer is at a location remote from the visual display measurement device.

13. A system, comprising:
a light collection cone configured to contact one or more selected portion of a visual display sign under test, wherein the light collection cone comprises a first end configured to contact the visual display sign, a second end spaced apart from the first end, and an optical axis extending between the first end and the second end;
a color measurement device carried by the light collection cone and adjacent to the second end of the light collection cone, wherein the color measurement device is configured to receive light from the visual display sign under test after the light passes along the optical axis from the first end to the second end; and
a test interface operably coupled to the color measurement device, wherein the test interface comprises a processor and memory and is configured to—compile and manage color and brightness data from the color measurement device;
calculate correction factors for the color and brightness data based on reference color and brightness data; and
upload the processed correction data to firmware and/or software controlling the visual display sign under test.

14. The system of claim 13 wherein the light collection cone further comprises a housing composed of opaque material.

15. The system of claim 13 wherein the first end of the light collection cone has a first cross-sectional diameter, and wherein the first cross-sectional diameter is less than a second cross-sectional diameter of the visual display sign.

16. The system of claim 13 wherein the color measurement device comprises a CCD spectrometer.

17. A method for measuring and calibrating a visual display, the method comprising:
receiving color and brightness data from one or more selected portions of a visual display sign using a handheld visual display measurement device, wherein the visual display measurement device includes (a) a light collection cone configured to directly contact the one or more selected portions of the visual display sign under test, and (b) a color measurement device carried by the light collection cone and configured to receive light from the visual display sign after the light passes through the light collection cone; and
calculating correction factors for color and brightness data from the color measurement device, wherein the correction factors are calculated using a computing device operably coupled to the color measurement device.

18. The method of claim 17, further comprising sending the correction factors to firmware and/or software controlling the visual display sign.

19. The method of claim 17 wherein the light collection cone comprises a front end and a back end spaced apart from the front end, and wherein the method further comprises:
directly contacting the visual display sign with the front end of the light collection cone such that the one or more selected portions of the visual display sign under test are covered by the front end of the light collection cone before receiving the color and brightness data, and wherein the light collection cone is held generally stationary against the visual display sign while receiving the color and brightness data.

20. The method of claim 19 wherein directly contacting the visual display sign with the front end of the light collection cone occurs onsite at the location of the visual display sign and without disassembling or modifying the visual display sign before testing.
